(19) United States
(12) Patent Application Publication
(10) Pub. No.: US 2012/0179797 A1
(43) Pub. Date: Jul. 12, 2012

(54) METHOD AND APPARATUS PROVIDING HIERARCHICAL MULTI-PATH FAULT-TOLERANT PROPAGATIVE PROVISIONING

(75) Inventor: Ranjan Sharma, New Albany, OH (US)

(73) Assignee: ALCATEL-LUCENT USA INC., Murray Hill, NJ (US)

(21) Appl. No.: 13/004,205

(22) Filed: Jan. 11, 2011

(51) Int. Cl. G06F 15/173

(52) U.S. Cl. 709/223

(57) ABSTRACT

A method for provisioning networked servers includes virtually linking networked servers in hierarchical layers to form a virtual tree structure. The virtual tree structure including a plurality of nodes corresponding to the networked servers. The plurality of nodes including a root node in a top layer and at least two nodes in a second layer. The root node linked directly or indirectly to at least two terminal nodes in one or more lower layers of the virtual tree structure in a node-to-node manner based at least on layer-to-layer linking between nodes from the top layer to the one or more lower layers. The method also including receiving a provisioning change at the root node of the virtual tree structure and propagating the provisioning change from the root node to the other nodes in a node-to-node manner based at least in part on the virtual tree structure.

### BACKGROUND

This disclosure relates to techniques for propagating provisioning changes through multiple networked servers within a communication network to improve the efficiency and quality in changing provisioning parameters across networked servers in which the same provisioning is desired. For example, this disclosure describes exemplary embodiments of a method and apparatus for provisioning networked servers in a charging collection function (CCF) of a billing system for a telecommunication service provider. However, the methods and apparatus described herein may be used in other types of networks to provision servers or other types of networked devices where the same provisioning is desired across multiple devices. As can be appreciated by those skilled in the art, examples of multiple servers or other devices where the same provisioning may be desired includes devices that provide parallel or distributed processing functions, mirroring functions, or backup functions.

For example, a CCF is used to collect accounting information from the network elements of an internet protocol (IP) multimedia subsystem (IMS) network for a post-paid billing system. In a typical deployment, it is common to see multiple servers engaged for this purpose. In general, these servers are normally only set up at the time of deployment and continue to provide service indefinitely. When the IMS service provider performs a network upgrade, or adds network elements that contribute charging information for subscriber usage of the network, or wishes to modify the functional behavior of the CCF servers, a need arises to make provisioning changes on the servers. Typical provisioning needs are handled in a telecommunications network via a dedicated element management system (EMS) that is capable of handling the provisioning of multiple disparate platforms at the same time. However, in a multi-vendor environment, it is unlikely that a provisioning capability can be provided that can adequately address servers of different types geared towards handling different tasks, when they stem from different vendors, or use different operating systems, protocols and databases. At the same time, it has been found cost-ineffective to bundle an EMS with CCFs alone in such deployments, since conceivably, each vendor would require their own EMS to handle their servers in the deployment which would be very expensive from the network operator's perspective.

The problem with existing networks is two-fold: a) a multi-vendor deployment scenario makes the deployment of a central EMS to handle multiple vendors and platforms extremely difficult, especially when provisioning changes deal with proprietary information that can reveal data design and capabilities of a vendor and consequently the vendor is unwilling to share such information and b) in such deployments, bundling a separate management system to handle the CCFs is cost-prohibitive.

Existing solutions use local provisioning via graphical user interface (GUI) menus that are available on the CCF platform. The operator logs into the server via proper credentials that allow access to the configuration menus. The operator modifies one or more parameters in the relevant GUI form, saves the changes and closes the session. Certain changes require a service re-start. The main drawback of this approach is that the changes are made locally on each server. In other words, for a network with multiple servers, the provisioning changes must be repeated individually on each server. This is particularly a problem for networks with tens or more of servers. Individual upgrades to the servers is time-consuming because it is a serial activity and has a tendency of eating up the maintenance windows (MWs) that the service providers very reluctantly release to vendors. A consequential drawback with this approach is that there is no network-wide view of provisioned parameters being in sync. For instance, there is nothing that prevents an operator from setting an alarm limit at 50% disk usage on server 1 and setting the same limit for 90% disk usage on server 2. This can result in complete disarray if alarms are generated from servers with different alarm limits because there is no way of telling if the alarm is minor, major or critical if the servers are provisioned differently by the operator.

For these and other reasons, individual provisioning is not recommended. Based on the foregoing, a need exists for a robust provisioning mechanism that can be created on the deployed servers themselves without depending on an external platform or external interfaces.

### SUMMARY

In one aspect, a method for use in a networked server is provided. In one embodiment, the method includes: virtually linking a plurality of networked servers in hierarchical layers to form a virtual tree structure, the virtual tree structure comprising a plurality of nodes corresponding to the plurality of networked servers, the plurality of nodes including a root node in a top layer and at least two nodes in a second layer, the root node linked directly or indirectly to at least two terminal nodes in one or more lower layers of the virtual tree structure in a node-to-node manner based at least on layer-to-layer linking between nodes from the top layer to the one or more lower layers; receiving a provisioning change at the root node of the virtual tree structure; and propagating the provisioning change from the root node to the other nodes in a node-to-node manner based at least in part on the virtual tree structure.

In another aspect, a method for provisioning networked servers is provided. In one embodiment, the method includes: establishing a virtual tree structure to organize a plurality of networked servers in hierarchical layers, the virtual tree structure comprising a plurality of nodes corresponding to the plurality of networked servers, the plurality of nodes including a root node in a top layer and at least two nodes in a second layer, the root node linked directly or indirectly to at least two terminal nodes in one or more lower layers of the virtual tree structure in a node-to-node manner based at least on layer-to-layer linking between nodes from the top layer to the one or more lower layers; receiving a provisioning change at the root node of the virtual tree structure where the provisioning change can be initiated from any of the nodes in the network; inhibiting subsequent provisioning changes to the plurality of networked servers while the current provisioning change is being processed; propagating the provisioning change from the root node to the other nodes in a node-to-node manner based at least in part on the virtual tree structure; and enabling subsequent provisioning changes to the plurality of networked servers after the current provisioning change has been processed.

In yet another aspect, an apparatus for provisioning networked servers is provided. In one embodiment, the apparatus includes: a communication network comprising a plurality of networked servers, at least one networked server comprising: a tree management module for establishing a virtual tree structure to organize the plurality of networked servers in hierarchical layers, the virtual tree structure comprising a plurality of nodes corresponding to the plurality of networked servers, the plurality of nodes including a root node in a top layer and at least two nodes in a second layer, the root node linked directly or indirectly to at least two terminal nodes in one or more lower layers of the virtual tree structure in a node-to-node manner based at least on layer-to-layer linking between nodes from the top layer to the one or more lower layers; a provisioning communication module adapted to receive a provisioning change from an operator graphical user interface (GUI) used by a work station in operative communication with the corresponding networked server; a network communication module for sending the provisioning change to the root node from the node at which the order was received if the order was not received at the root node; and a provisioning management module in operative communication with the tree management module and network communication module for inhibiting subsequent provisioning changes to the plurality of networked servers while the current provisioning change is being processed, propagating the provisioning change from the root node to the other nodes in a node-to-node manner based at least in part on the virtual tree structure, and enabling subsequent provisioning changes to the plurality of networked servers after the current provisioning change has been processed.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a diagram of an exemplary embodiment of a process for provisioning networked servers using a percolation approach;

FIG. 2 is a diagram of an exemplary embodiment of a process for provisioning networked servers using a percolation approach with peer redirection;

FIG. 3 is a diagram of an exemplary embodiment of a process for provisioning networked servers in a network view adapted to implement multi-path and fault-tolerant features;

FIG. 4 is a diagram of an exemplary embodiment of a process for provisioning networked servers using a virtual tree structure adapted to implement provisioning propagation features;

FIG. 5 is a diagram of an exemplary embodiment of a process for provisioning networked servers adapted to implement a lock-step mechanism with reverse hierarchical acknowledgment flow features;

FIG. 6 is a diagram of an exemplary embodiment of a process for provisioning networked servers adapted to implement features for handling a terminal node outage;

FIG. 7 is a diagram of an exemplary embodiment of a process for provisioning networked servers adapted to implement features for handling a missing ‘acknowledgment’ from an out of service (OOS) terminal node;

FIG. 8 is a diagram of an exemplary embodiment of a process for provisioning networked servers adapted to handle processing at recovery of a terminal node;

FIG. 9 is a diagram of an exemplary embodiment of a process for provisioning networked servers adapted to implement features for handling an intermediate node outage;

FIG. 10 is a diagram of an exemplary embodiment of a process for provisioning networked servers adapted to handle processing at recovery of an intermediate node;

FIG. 11 is a diagram of an exemplary embodiment of a process for formulation of a virtual tree structure for use in conjunction with provisioning networked servers;

FIG. 12 is a diagram of an exemplary embodiment of a process for re-formulation of a virtual tree structure in conjunction with a root node outage;

FIG. 13 is a diagram of an exemplary embodiment of a process for re-formulation of a virtual tree structure in conjunction with insertion of a node into an existing tree;

FIG. 14 is a flow chart of an exemplary embodiment of a process for use in networked server in conjunction with provisioning networked servers;

FIG. 15 is a flow chart of an exemplary embodiment of a process for provisioning networked servers;

FIG. 16 is a block diagram of an exemplary embodiment of a communication network with a plurality of networked servers organized in an exemplary virtual tree structure; and

FIG. 17 is a block diagram of an exemplary embodiment of a networked server within an exemplary communication network with a plurality of networked servers.

### DETAILED DESCRIPTION

Various embodiments of methods and apparatus for provisioning networked servers are disclosed herein. The method and apparatus finds usefulness in networks in which it is desirable for configurable parameters, settings, and selections multiple networked servers to be provisioned in the same manner. The network may utilize the multiple networked servers in parallel with resource management to maximize throughput, as standby servers to manage overflow, or as redundant servers to enhance reliability during failure conditions. For example, the multiple networked servers may provide certain charging functions in a charging system for a telecommunications service provider. In this exemplary application, the multiple networked servers may provide charging data functions (CDFs), charging gateway functions (CGFs), or combination of data and gateway functions in charging collection functions (CCFs).

The basic idea is to use existing single-server provisioning forms to provision the networked servers, but instead of using the forms to make the changes on each networked server locally, provide a means to spread the changes made on one server to other commonly-provisioned servers in the network.

For the initial provisioning and provisioning changes, an operator can choose any of the existing servers in the deployment. Various embodiments of the method and apparatus for provisioning networked servers can implement and combination of features so that changes made on the server selected by the operator can be reliably propagated to the other networked servers in a way that prevents race conditions, handles loss of servers in the network gracefully, and allows the concept of a “flying master.” These features are enumerated here and described in additional detail below: 1) fault-tolerant with respect to failure of one or multiple servers, 2) blocking simultaneous provisioning from multiple sources, 3) permitting any networked server to be the input node (i.e., no fixed “input master”), 4) version management and maintaining records of provisioning changes, 5) no need for a separate provisioning platform, 6) providing higher reliability through the alternate “master” arrangement of the networked serve, 7) propagation of provisioning using multiple “parallel” streams does not require sequential provisioning through the nodes, as the provisioning changes descend each layer of hierarchy, the count of parallel streams increases exponentially; and 8) server failures are non-blocking for provisioning of the available networked servers.

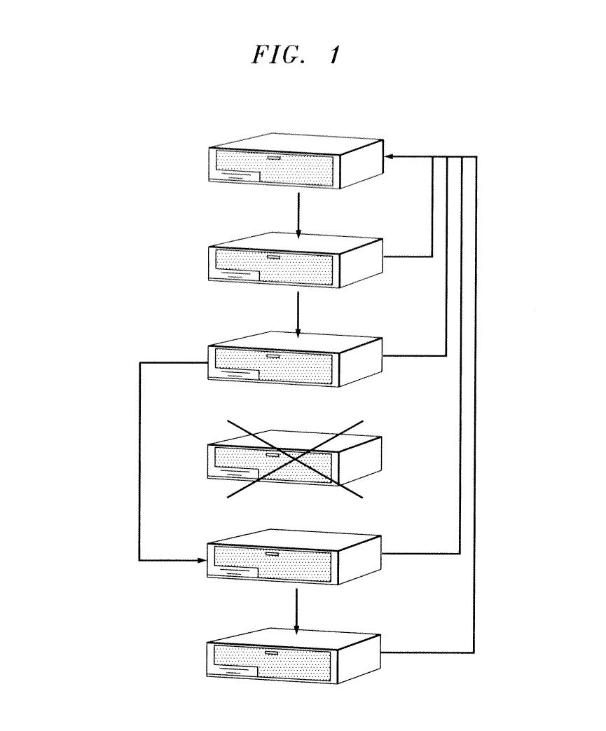

In one exemplary embodiment, cabinet-wide provisioning may be provided using a percolation approach (see FIG. 1). It is common for servers to be deployed in a rack-mounted cabinet arrangement. Each cabinet of servers may include four, six or eight servers, depending on the cabinet and server dimensions, as well as NEBS compliance guidelines etc. In this embodiment, one can designate a server that occupies a higher vertical slot to be responsible for provisioning the server that is directly underneath it. The server that updates itself with the changes must report back to the top server for a status update. If a server happens to be out of service (OOS), the server above it may bypass it and go to the next operational server below the OOS server. The OOS server does not report back to the top server with its status update, so the top server knows that the cabinet is not fully provisioned with the changes. The top server in the chain acts as a guard against simultaneous provisioning requests until all servers in the cabinet have been upgraded with the last set of changes. Some concerns with this approach are addressed in the additional features described below. For example, techniques for contacting the top-most server to initiate the provisioning change and preventing two or more different versions of parameters in two or more cabinets of networked servers.

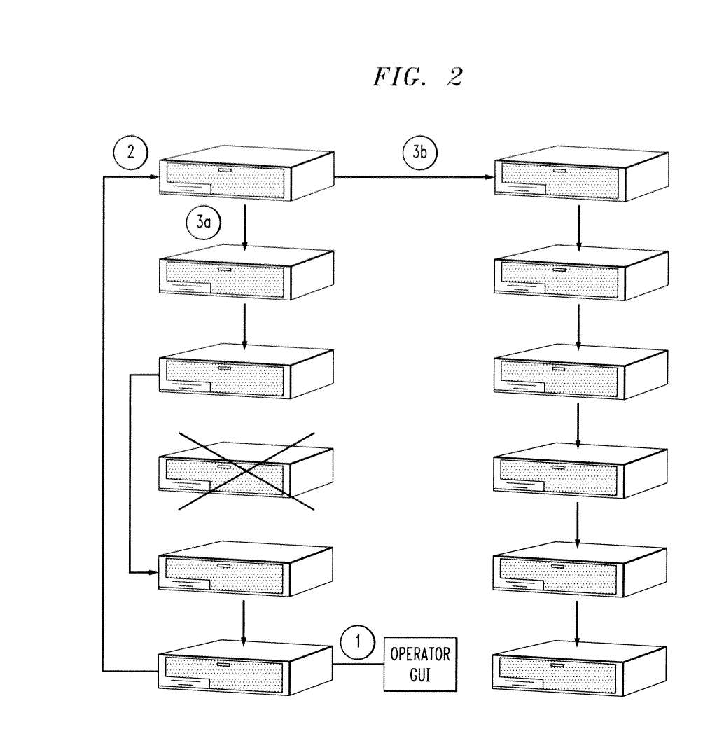

In another embodiment, the percolation approach with peer-redirection is provided (see FIG. 2). In this embodiment, any server in any cabinet can offer an operator GUI (1) to an operator for introduction of the provisioning change. The server that receives the provisioning change from the operator contacts the top server (2) in the cabinet and indicates the changes needed. The top server starts the percolation process (3a) and propagates the changes to other top servers (i.e., peers) in other cabinets (3b). For the sake of simplicity, ‘acknowledgments’ to the top server are not shown in either chain from individual servers. In this embodiment, the provisioning is known at a top server in each single cabinet, but there is no network-wide view of provisioning changes. So, if an operator makes other provisioning changes via an operator GUI on a different server chain in another cabinet, there is a potential for clash in processing multiple provisioning changes at the same time.

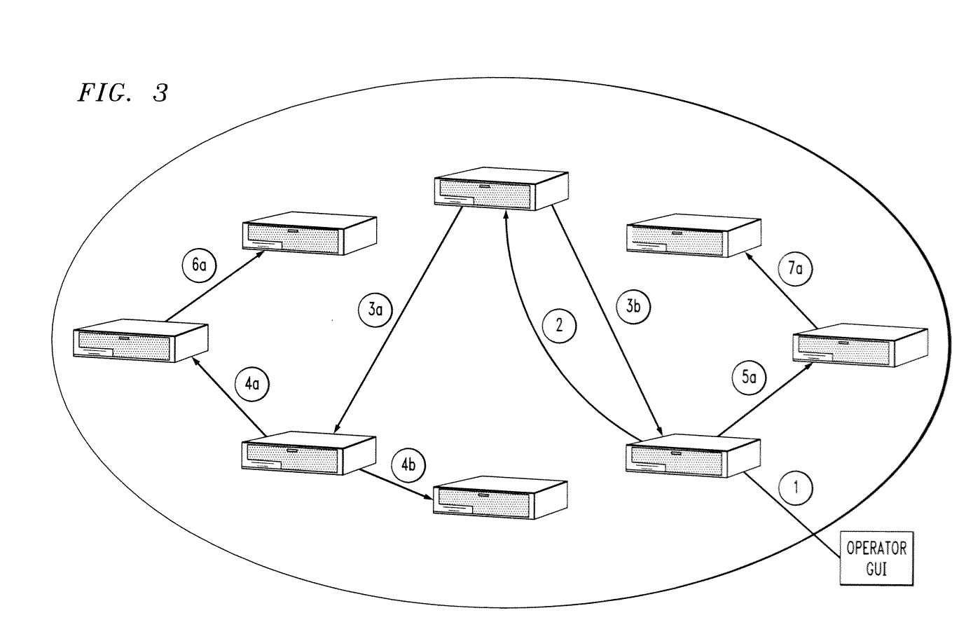

In yet another embodiment, a network-wide provisioning view with hierarchical multi-path provisioning is provided (see FIG. 3). When provisioning changes are made to a network, all servers are affected in a similar way. If a network-wide view is taken, provisioning changes can be propagated via multiple paths at each hierarchical level. This can enhance propagation in an exponential manner. For example, starting from the root of a virtual binary tree, the subsequent layers may comprise two, four, eight, sixteen, etc. servers that are modified at each step of the propagation. In this embodiment, each server communicates with its adjacent layers. FIG. 3 shows the provisioning flow with numbered arrows to illustrate the multiple paths and the exponential propagation.

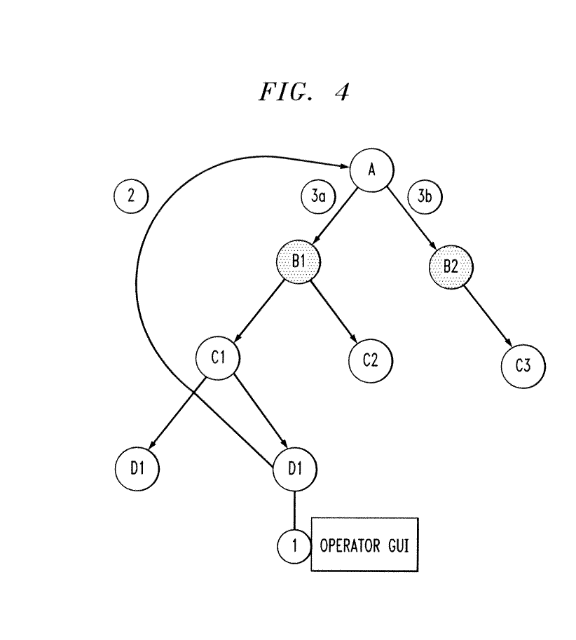

In the embodiment being described, the provisioning follows a virtual tree structure. An operator may use a graphical user interface (GUI) (1) on any server in the network. The server receiving the provisioning via the GUI contacts the root of the virtual tree (2) and provides the modifications done via an agreed-to XML notation. The root then contacts the nodes on the left (3a) and right (3b) and propagates the changes to them. As propagation of the provisioning change continues (see FIG. 4), the branch nodes are responsible for propagating the provisioning changes to further branch and leaf nodes.

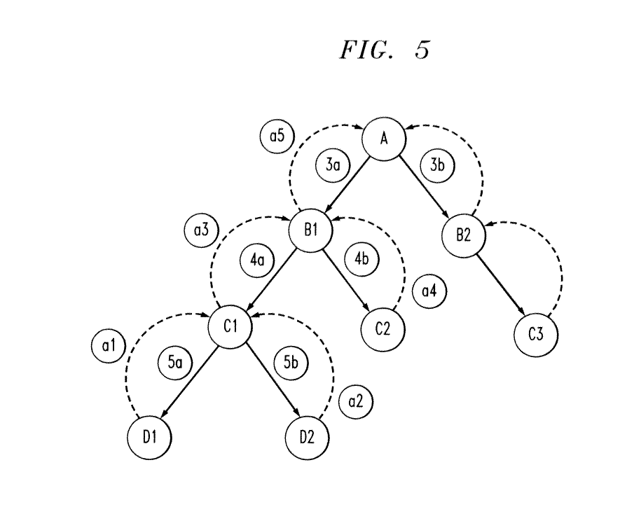

When there are no “child nodes” remain (i.e., when terminal nodes are reached), ‘acknowledgments’ starts flowing up the chain toward the root node. As shown in FIG. 5, ‘acknowledgments’ a1 and a2 are received (in any order) by an intermediate node, before a3 is issued up the chain toward the root node. Similarly, both a3 and a4 must have been received (in any order), before a5 is issued by another intermediate node up the chain to the root node. When a5 is received at the root, it is understood that the nodes on the left side of the tree have been completely provisioned. Similarly, the nodes on the right hand side receive and acknowledge the provisioning change.

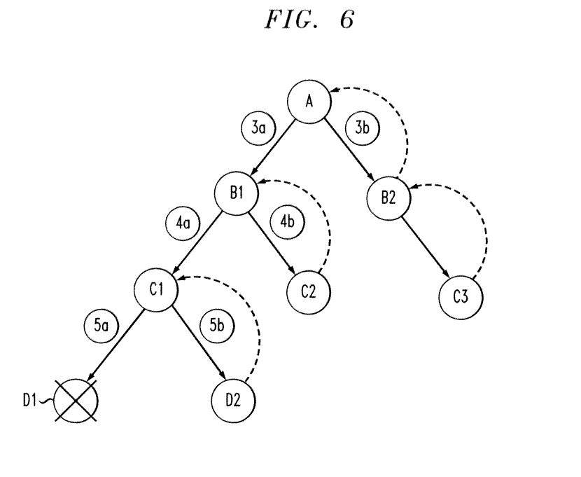

In the embodiment being described, FIG. 6 shows resiliency of the system for provisioning networked servers in handling a terminal leaf outage. As shown, propagation of the provisioning change (5a) cannot execute since there is a server outage. The corresponding server is referred to as a terminal node because there are no more leaves under it in the virtual tree structure. With the terminal node outage, the chain to the left of the root node cannot send back positive ‘acknowledgments’ even though the chain on the right (5b) can return an ‘acknowledgment’ to the intermediate node from which it received the provisioning change. In this situation, since step 5a is stopped, while the ‘acknowledgments’ for 5b (and also 4b) can be in place, the 5a ‘acknowledgment’ does not reach the upper layer, nor can the ‘acknowledgment’ for 4a or 3a.

In the embodiment being described, each node can have zero, one, or two nodes underneath it in the virtual tree structure. Nevertheless, in other embodiments, a node may be responsible for provisioning three or more nodes. For example, when a provisioning or heartbeat communication with another node fails, the corresponding node can refer to the virtual tree structure to bypass around one or more out-of-service (OOS) node to continue propagation of the provisioning change along the virtual tree structure. Each node must “know” which other nodes it is responsible for propagation of provisioning changes. This may be arrived at by deriving a “tree map” at each node. In one embodiment, each node accounts for the ‘acknowledgments’ from nodes under it before sending an ‘acknowledgment’ to the node in an upper layer from which it received the provisioning change.

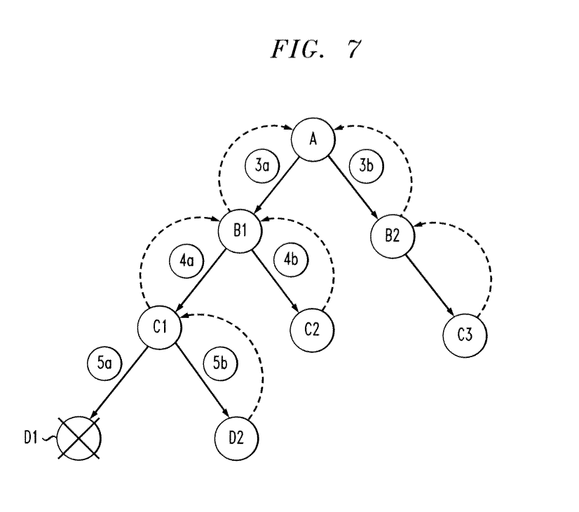

With reference to FIG. 7, another embodiment may handle lack of ‘acknowledgment’ from a terminal node in a different manner. For example, since the root node did not get an ‘acknowledgment’ from the left side of the tree, the root node could query the nodes accessed via 3a recursively to find determine the specific status of each node; thereby identifying the one or more nodes that are out of service which caused ‘acknowledgment’ of the left branch to be withheld.

Another option is for the node closest to the OOS node to report the outage. For example, since 5a was not “acknowledged” within a predetermined reasonable time, the node attempting to supply the provisioning change via 5a could provide a failure message up the chain that indicates that the provisioning change failed because the terminal node did not respond with an ‘acknowledgment’ (i.e., the terminal is OOS). For the embodiment being described, each node could maintain a timer for ensuring that the nodes underneath report back with an ‘acknowledgment’ within a predetermined time. However, since the reasonable time for a response would vary based on the depth of the tree, the predetermined time would be a multiple of the layers from the corresponding node to the farthest terminal node in the branch. Moreover, if the corresponding node does not know the depth of the tree a-priori, the embodiment being described might require special handling to ensure that timer maintenance is tied to tree management.

In yet another embodiment, each node could maintain a bidirectional heartbeat with its upper and lower layers, where available. Terminal nodes of course are not linked to nodes in any lower layer. Similarly, the root node is not linked to nodes in any upper layer. In order to know the “heartbeat buddies” (i.e., the nodes with which each node must maintain a heartbeat), a map of the tree is needed and each node could maintain at least a portion of the tree corresponding to other nodes to which it is directly linked in upper and lower layers. Each node may calculate the tree structure in its initial start-up phase.

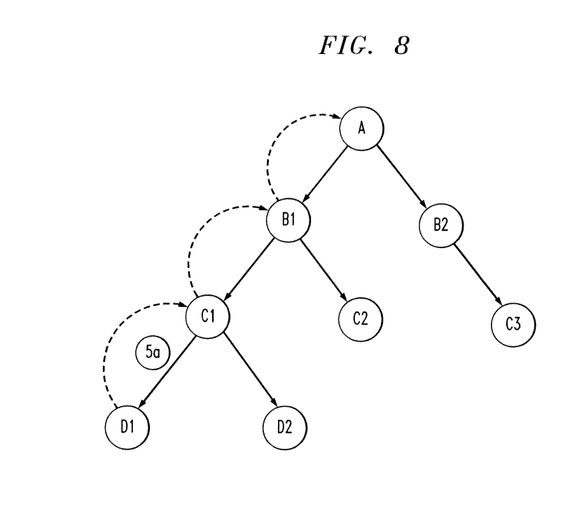

With reference to FIG. 8, provisioning changes may be propagated to failed terminal nodes after recovery of the corresponding terminal node. The tree nodes, including the root node, may maintain a status table for provisioning updates. When the terminal OOS node recovers, it may re-establish heartbeat messaging with the upper layer node that was originally responsible for propagation of the provisioning change to the terminal OOS node. After the successful heartbeat messaging exchange, the upper layer node can propagate the provisioning changes to the recovered terminal node. Upon receipt of the ‘acknowledgment’ from the terminal node that the provisioning changes were received, the upper layer node can send the ‘acknowledgment’ in the upward direction toward the root node. Similarly, any intermediate nodes in this chain holding ‘acknowledgments’ due to the previous failure of the terminal node can now send the ‘acknowledgment’ toward the rood node. Upon receiving the ‘acknowledgment,’ the root can check off the node and change the network status for the provisioning order to complete, if there are no other OOS nodes.

The status table maintained by the tree nodes may include data that pertains to the provisioning order identification, date and time the provisioning order was issued, and a status field that captures the progress and completion, including any outages (e.g., OOS nodes). The status value of ‘0’ indicates a successful completion of propagation of the provisioning change the corresponding network servers. A list of node identifiers in the status field would indicate OOS servers or nodes/branches where the provisioning change has failed (i.e., provisioning change was not fully acknowledged). Even if an order is not complete, an operator may be allowed to issue a second order and a third order because these are serialized.

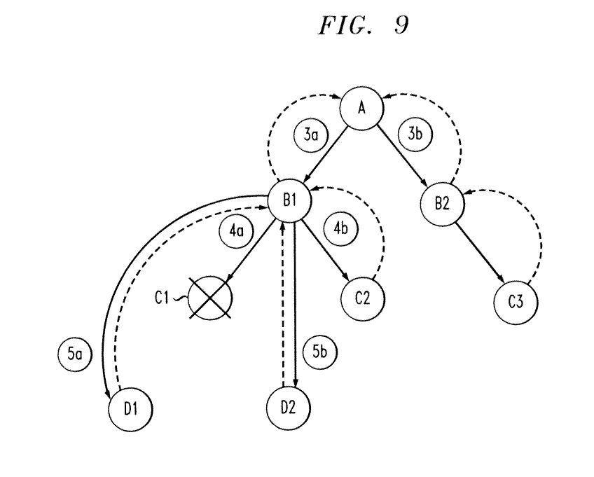

With reference to FIG. 9, another embodiment reflects how the system for provisioning networked servers can handle failure of a non-terminal (i.e., intermediate) node. In this embodiment, 4a would fail since the provisioning target node (node C1) for provisioning command 4a, which is an intermediate node or non-terminal node, is OOS. The node at the next higher level (node B1) is now responsible for the nodes D1 and D2 below the node C1. This provides an immediate layer of resilience for continuing to propagate the provisioning change by bypassing intermediate nodes that are OOS (e.g., node C1). Note that the tree map is available to each node to see which children nodes or grandchildren nodes would need provisioning in such failure cases (or even normal cases). The node failure of the non-terminal (i.e., intermediate) node may also be communicated to the root node which maintains and tracks the status of each provisioning request. Double failures (i.e., two or more networked server failures at the same time) are also possible. In FIG. 9, steps 5a or 5b can run into issues if the servers in question develop faults and go OOS. FIG. 9 provides an example where one intermediate node (node B1) becomes responsible for three nodes (i.e., nodes C2, D1, and D2) because the intermediate node (node C1) that normally handles 4a is OOS. Thus, the intermediate node (node B1) that normally provides 4a to the intermediate node (node C1) that is OOS provides 5a and 5b to the terminating nodes (nodes D1 and D2) that would normally be provisioned by the OOS node (node C1).

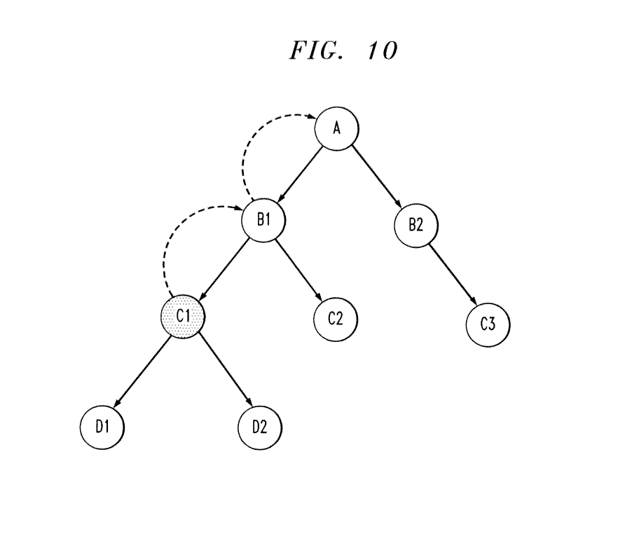

With reference to FIG. 10, provisioning changes may be propagated to failed intermediate nodes after recovery of the corresponding intermediate node. When it recovers, the recovered intermediate OOS node (i.e., shaded) may re-establish heartbeat messaging with the nodes at adjacent layers to which it is directly linked. The upper layer node being the node originally responsible for propagation of the provisioning change to the intermediate OOS node. After the successful heartbeat messaging exchange, the upper layer node can propagate the provisioning changes to the recovered intermediate node. Upon receipt of the ‘acknowledgment’ from the intermediate node that the provisioning changes were received, the upper layer node can send the ‘acknowledgment’ in the upward direction toward the root node. Similarly, any intermediate nodes in this chain holding ‘acknowledgments’ due to the previous failure of the intermediate node can now send the ‘acknowledgment’ toward the root node. Upon receiving the ‘acknowledgment,’ the root can check off the node and change the network status for the provisioning order to complete, if there are no other OOS nodes. If there are other nodes that are currently OOS, these nodes would show up in the entry.

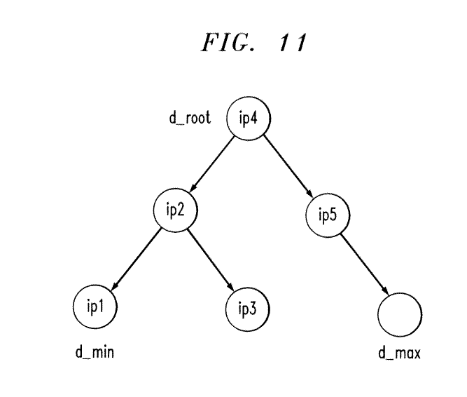

With reference to FIG. 11, an exemplary embodiment of a process to form the tree map or virtual tree discussed in the preceding sections is depicted. The tree may be formed at the start-up phase of each server. The exemplary process may be implemented for an IPv4 addressing scheme or an IPv6 addressing scheme. If there is a mixed mode deployment that uses both IPv4 or IPv6 in any combination of multiple addressing schemes, the process can be modified in any suitable manner to accomplish a similar, suitable resulting tree. Further, the exemplary process presumes the subnet for servers being provisioned is the same. That is, in the “a.b.c.d” form, the “a.b.c” are common. For example, if six servers are deployed, each can get a value of ‘d’ between 0 and 255. An algorithm for the exemplary process in a network using IPv4 addressing scheme uses the parameters: i) d_min—minimum value of the 4th octet in the deployment and ii) d_max—maximum value of the 4th octet in the deployment to determine d_root=(d_min+d_max)/2. It is noted here that the process is not limited to assuming the subnet to be the same; a hash function can alternatively be employed on the IP address to arrive at a sorted ordered list of servers to be provisioned. Also, the exemplary process using IPv4 addressing scheme is not to be construed as a limiting factor; a similar method can be used on the least significant ‘n’ bits of IPv6 addressing scheme as well, choosing ‘n’ suitably so as to encompass all nodes in the deployment.

A sorted list may be created based on the ascending IP addresses of the nodes. For example, the list can be identified as: ip1 (the 4th octet has d_min), ip2, ip3, ip4, ip5, ip6 (the 4th octet has d_max). Assuming d_root is closest to ip4, ip4 becomes the root. The left child node of ip4 is selected by choosing the mid-point in the (d_min, d_root) range. Similarly, the right child of ip4 is chosen by finding the midpoint in the (d_root, d_max) range. This process is used recursively to select the networked server for the next node as the virtual tree is formed until there is no longer any IP address between the corresponding d_min and d_max for that portion of the tree. If gaps between IP addresses for the networked servers are generally balanced, the resulting tree is expected to be more or less balanced.

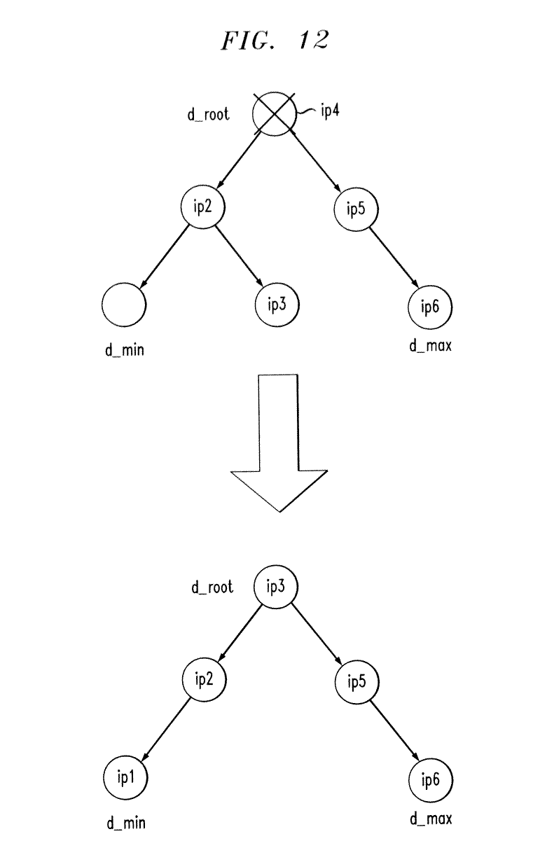

With reference to FIG. 12, another embodiment reflects how the system for provisioning networked servers can handle a failure of a root node. For example, in this embodiment, ip4 may happen to be the IP address for the root node of the virtual tree and may currently be OOS. If an order for a provisioning change is received from the node with an IP address of ip1, the ip1 node would determine that ip4 root node is OOS. The ip1 node may determine the ip4 root node is OOS after sending the provisioning change to ip4 root node and not receiving an ‘acknowledgment’ within a predetermined time. Alternatively, the ip1 node may determine the ip4 root node is OOS from status information stored in a local storage device or stored in remote storage device accessible to the ip1 node. After determining the ip4 root node is OOS, the ip1 node knows the virtual tree must be reconstructed with a different root node. The ip1 node may broadcast the OOS status for the root node and each node may reformulate the tree structure. Alternatively, the ip1 node may reformulate the virtual tree and each node may be notified via a message about the change.

Reformulation of the virtual tree is based on knowledge of the IP addresses for the nodes. The IP addresses for the nodes are ip1 (d_min), ip2, ip3, ip4, ip5, ip6 (d_max) for the example being described herein. In the algorithm described above, d_root is closest to ip4, but ip4 is OOS. Assuming ip3 is the next closest to d_root, the ip1 node selects ip3 as the root node. Then, the tree is formed under ip3 in the same manner as described above. If ip1 selected the new root node and re-formulated the tree, it may broadcast a message about the new virtual tree to other nodes by sending a message on the subnet “a.b.c.xxx.”

In various embodiments of methods and systems for provisioning networked servers described herein, when an order for provisioning changes are initiated by an operator connected to any one of the servers, the corresponding server obtains a ticket number for the order based on the current version/revision of provisioning parameters that it hosts in conjunction with the provisioning changes. Conceptually, the new ticket number (i.e., provisioning change identifier) could simply be generated as a running number (e.g., N=N+1). The ticket number could be provided in a message on the broadcast channel to affect a Mutex (i.e., no other server would allow firing up a GUI screen for provisioning under this situation) to prevent race conditions associated with processing multiple orders for provisioning changes at the same time. In practice, the “N” notation for the current ticket number would be constructed at each node individually and may be guaranteed to be unique network-wide. The uniqueness can be attributed to the composition of the ticket. For example, the ticket number may be indicative of date, time, originating node's identification (e.g., IP address or node name or similar), and a locally maintained serial number in any suitable combination.

Each node that receives the broadcast message for the order may add the provisioning change to its locally maintained status table and may mark the provisioning status for this update (i.e., change) as “In progress.” Measures are taken to ensure there is not more than one provisioning change with an “in progress” status in the status table.

If there is at least one node that is OOS, the status for the current ticket cannot be marked as “system complete” on all servers and the system will continue to inhibit processing of subsequent provisioning changes, unless a manual override is accomplished to enable processing of subsequent provisioning changes. For example, in cases where a node is irrecoverably lost or lost for an indeterminate time, the system can enable subsequent provisioning changes rather than wait for hardware modifications to the network. Similarly, in circumstances where the current provisioning change can be implemented with a degraded network having one or more OOS servers, the system can enable subsequent provisioning changes rather than wait for hardware modifications to the network. If the system can detect circumstances that permit such an override, the override may be automated to not require manual intervention.

In various embodiments of methods and systems for provisioning networked servers described herein, assuming an OOS node recovers, an exemplary process can be used to re-link the recovered node in the tree structure and continue propagation of provisioning changes that are not present in the recovered node. In one exemplary embodiment, the recovered node may consult its tree data and re-establish heartbeat messaging with nodes in layers above and below it with which it is directly linked in the tree structure. During the heartbeat messaging session, one or more directly linked node may inform the recovered node of the current provisioned state (e.g., “N+1”). The recovered node may examine its own provisioning status table to compare its provisioning status to the provisioning status of other nodes to which it is directly linked. In many cases, the recovered node would have a previous iteration of provisioning changes (e.g., N) because it missed at least one provisioning change while it was OOS. The provisioning status of the recovered node could be lower than N if “network complete” provisioning status was overridden for any provisioning changes missed while the node was OOS. The recovered node may get missed provisioning change packages from its parent node, update itself, and send an ‘acknowledgment’ to the parent. This ‘acknowledgment’ could be chained up to the root node and the root could mark the corresponding provisioning change with a “network complete” status if the other nodes have all been ‘acknowledged’ to the root node.

In various embodiments of methods and systems for provisioning networked servers described herein, mutual exclusion can be guaranteed as to simultaneous propagation of multiple provisioning changes. When changes are initiated by an operator connected to any of the servers, the corresponding server obtains a ticket number based on the current version/revision of parameters that it hosts. This new ticket number can be sent as a broadcast message to all available nodes. The originator of the broadcast then waits for a predetermined period of time (e.g., between Wait_min and Wait_max) for any contra-indications from any other node that may have initiated a different provisioning change. If no other node replies to the broadcast message with a negative response message (e.g., because a local provisioning screen is fired up on the corresponding node) before the predetermined time expires, the originating node sets an “in-progress” status on the ticket.

Another example of the process for mutual exclusion includes the originating node obtaining a ticket and broadcasting its intention to make provisioning changes under that ticket (e.g., ticket-number=N+1 in relation to the previous discussion on “N” where “N” is not a pure number). The originating node waits for a predetermined time for a negative response from any other node. If a negative response is received, it is an indication that another node is already trying to process a provisioning change and the broadcasting node broadcasts a follow-up message retracting ticket-number “N+1,” provides a message to its operator indicating the circumstances, and quits processing the provisioning change. If no negative response is received by the originating node, it changes the status for the provisioning change to “in-progress and resends the broadcast message for ticket-number “N+1” with the “in-progress” status. Each node that receives the “in-progress” message sets a marker to reflect the provisioning change is “in-progress” and disallows subsequent local provisioning changes to prevent any race conditions regarding propagation of multiple provisioning changes at the same time.

In various embodiments of methods and systems for provisioning networked servers described herein, changes for a given ticket number are provided by a parent node (or grandparent node) to a child node. When the child node finishes applying the changes, it mark the status of the corresponding ticket (i.e., provisioning change) as “locally complete.” The child node inform the parent node about the completion via an ‘acknowledgment’ or similar messaging that confirms the provisioning change was received and ready for activation. When these ‘acknowledgments’ reach the root, the root interprets them as a sign of completion at all the corresponding branches and leaves. The root then marks the status of the corresponding ticket (i.e., provisioning change) as “network complete” and issues a broadcast message to all available nodes with the status update. Each node receiving the “network complete” message can mark the status of the provisioning change as such. At this stage, each node is essentially ready to accept a new provisioning request and processing of subsequent provisioning changes is enabled. Conversely, processing of subsequent provisioning is disabled and nodes would prevent a new local provisioning session under the following circumstances: i) after receipt of a broadcast message from another node with an intent to process a provisioning change, ii) after the status for a ticket (i.e., provisioning change) is marked “in-progress” on the corresponding node, and iii) if the status for a ticket (i.e., provisioning change) is marked “locally complete” on the node. These techniques are used to allow (i.e., enable) or bar (i.e., inhibit) processing of subsequent provisioning changes in relation to the current provisioning change.

In various embodiments of methods and systems for provisioning networked servers described herein, creation and modification of the tree structure guides the sequence for propagation of provisioning changes through the plurality of servers in the network. The virtual tree structure is created when the servers (i.e., nodes) are first deployed in a network. The virtual tree structure is modified, for example, when the root of the tree becomes OOS. The virtual tree structure is also modified when nodes are removed from the network or added to the network.

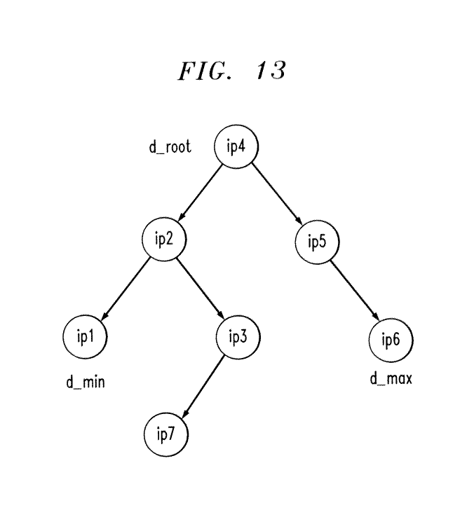

In various embodiments of methods and systems for provisioning networked servers described herein, the addition of nodes to the network involves attaching branches and leaves to the existing virtual tree structure. For example, insertion of a node in a binary tree is straightforward. With reference to the exemplary tree formulation above, if a node with an IP address of ip7 is to be inserted, the fourth octet of ip7 would determine its location in the virtual tree. If the value for the fourth octet of i7 is between that of ip1 and ip4, the insertion would be on the left side of the tree. The most likely position for this node in the tree would be under ip1 or ip3, depending on the value of the fourth octet of ip7 being less than or greater than the corresponding octet in ip2, respectively. If it is greater than the value of the fourth octet in ip2, but smaller than that of ip3, the position of ip7 is along the right branch from ip2 and along the left branch from ip3. This is shown in FIG. 13.

In various embodiments of methods and systems for provisioning networked servers described herein, provides multipath, fault-tolerant provisioning with ownership of provisioning changes by a flying master and mutex locks in a solution that finds use in a multi-vendor deployment or in a low-cost deployment where a dedicated or shared EMS is not ideal. The method and system for provisioning networked servers can be implemented in CCFs, CDFs, or CGFs associated with a billing system for a telecommunications service provider. Various embodiments described herein can also be implemented to handle provisioning of servers and other network elements in any type of network and network application that benefits from commonly provisioning multiple servers or other network elements. For example, mirroring and backup servers and other devices can be provisioned along with the corresponding primary device.

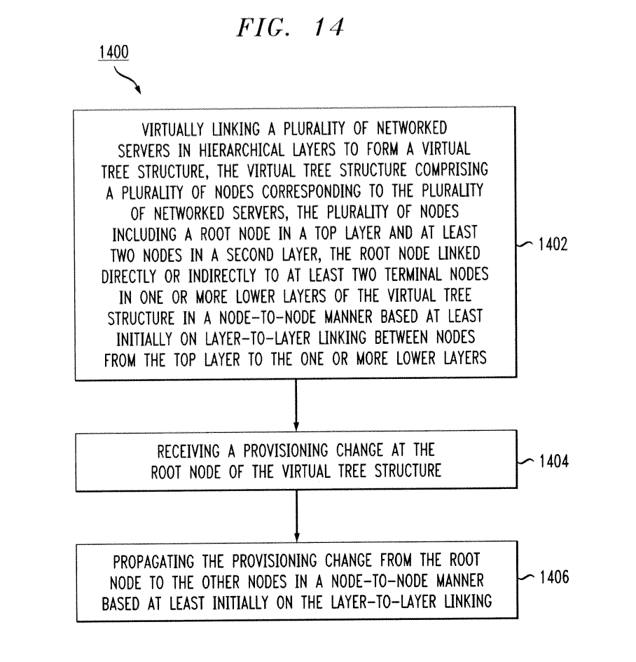

Referring again to the drawings wherein the showings are for purposes of illustrating the exemplary embodiments only and not for purposes of limiting the claimed subject matter, FIG. 14 depicts an exemplary embodiment of a process 1400 for use in a networked server in conjunction with provisioning networked servers begins at 1402 where a plurality of networked servers are virtually linked in hierarchical layers to form a virtual tree structure. The virtual tree structure including a plurality of nodes corresponding to the plurality of networked servers. The plurality of nodes including a root node in a top layer and at least two nodes in a second layer. The root node linked directly or indirectly to at least two terminal nodes in one or more lower layers of the virtual tree structure in a node-to-node manner based at least on layer-to-layer linking between nodes from the top layer to the one or more lower layers. Next, a provisioning change is received at the root node of the virtual tree structure (1404). At 1406, the provisioning change is propagated from the root node to the other nodes in a node-to-node manner based at least in part on the virtual tree structure.

In another embodiment of the process 1400, the virtual tree structure may be based at least in part on a binary tree structure. In the embodiment being described, the networked servers may be deployed within a network and assigned internet protocol (IP) addresses. In this embodiment, the process 1400 may also include identifying a minimum value (d_min) among the IP addresses assigned to the networked servers, identifying a maximum value (d_max) among the IP addresses assigned to the networked servers, and determining a mean value (d_root) from the minimum and maximum values based at least in part on (d_min+d_max)/2. In the embodiment being described, the networked server with a value for the assigned IP address closest to the mean value may be selected as the root node for the virtual tree structure. For example, a floor or ceiling preference may be used if values for two IP addresses are equally close to the mean value. In this embodiment, left branches of the virtual tree structure may be formed by recursively setting the IP address for the previously selected networked server to d_max, determining the mean value, and selecting the networked server for the next node as performed for the root node until there are no further IP addresses with values between d_min and d_max. Similarly, right branches of the virtual tree structure may be formed by recursively setting the IP address for the previously selected networked server to d_min, determining the mean value, and selecting the networked server for the next node as performed for the root node until there are no further IP addresses with values between d_min and d_max.

In another embodiment, the process 1400 may also include receiving an order for the provisioning change at any node of the virtual tree structure. In this embodiment, if the order was not received at the root node, the provisioning change may be sent to the root node from the node at which the order was received.

In a further embodiment, the networked server represented by the node at which the order was received may be in operative communication with a work station adapted to use an operator graphical user interface (GUI) from which the order was sent.

In another further embodiment, the process 1400 may also include discontinuing further processing of the current order for the provisioning change at the networked server at which the current order was received if another order for a previous provisioning change is in progress in relation to the plurality of networked servers. Otherwise, this alternate further embodiment includes broadcasting a change intention message from the node at which the current order was received to other nodes of the virtual tree structure. If a negative response message to the change intention message is received from any of the other nodes within a predetermined time after broadcasting the change intention message, the node at which the order was received may broadcast a retraction message to the other nodes to retract the change intention message and discontinue further processing of the current order. Otherwise, this alternative further embodiment includes broadcasting a change in-progress message to the other nodes to inhibit the other nodes from processing subsequent provisioning changes while the current provisioning change is being processed.

In yet another further embodiment, the process 1400 may also include assigning a change identifier to the order and the provisioning change at the node at which the order was received. The change identifier uniquely identifies the order and the provisioning change in relation to other provisioning changes for the plurality of networked servers.

In another embodiment of the process 1400, non-terminal nodes of the virtual tree structure may propagate the provisioning change to nodes indirectly linked to the corresponding non-terminal node in lower layers of the virtual tree structure to bypass “out of service” nodes directly and indirectly linked to the corresponding non-terminal node.

In still another embodiment of the process 1400, the virtual tree structure may include at least one intermediate node between the root node and the terminal nodes. In this embodiment, each networked server may maintain status information for at least a portion of the virtual tree structure in a local storage device. The root node may maintain status information with status records for each node of the virtual tree structure. Each terminal node may maintain status information with status records for at least itself and the node in higher layers of the virtual tree structure to which it is directly linked. Each intermediate node may maintain status information with status records for at least itself, the node in higher layers of the virtual tree structure to which it is directly linked, and each node in lower layers of the virtual tree structure to which it is directly or indirectly linked. Each status record may be adapted to store a node identifier, a node status, a provisioning change identifier, a provisioning change status, a parent node identifier, and one or more child node identifiers.

In a further embodiment of the process 1400 the node identifier in each status record of the status information for each node may be based at least in part on an internet protocol (IP) address assigned to the networked server represented by the corresponding status record. In this embodiment, the node identifiers may be stored in the corresponding status information at the networked servers in relation to the establishing of the virtual tree structure.

In an even further embodiment of the process 1400, the parent node identifier in each status record of the status information for each intermediate and terminal node may be based at least in part on the IP address assigned to the networked server represented by the node in higher layers of the virtual tree structure to which the network node for the corresponding status record is directly linked. In this embodiment, the parent node identifiers may be stored in the corresponding status information at the networked servers in relation to the establishing of the virtual tree structure.

In a yet even further embodiment, for each non-root node of the virtual tree structure, the process 1400 may also include sending a heartbeat query message to the network node identified by the parent node identifier in the status record for the corresponding non-root node. In this embodiment, if the corresponding non-root node does not receive a heartbeat response message from the network node identified by the parent node identifier within a predetermined time after sending the corresponding heartbeat query message, the process 1400 may determine the node identified by the parent node identifier is out of service and store an “out of service” status in the node status of the status record for the node identifier that matches the parent node identifier in the status information for the corresponding non-terminal node.

In a still yet even further embodiment of the process 1400, the heartbeat query message to the network node identified by the corresponding parent node identifier may include the provisioning change identifier and provisioning change status for the corresponding non-root node. In this embodiment, the process 1400 may also include receiving a heartbeat response message from the network node identified by the corresponding parent node identifier and, if the provisioning change identifier and provisioning change status for the corresponding non-root node is behind the provisioning change identifier and provisioning change status at the network node identified by the corresponding parent node identifier, receiving the provisioning change from the network node identified by the corresponding parent node identifier at the corresponding non-root node.

In another even further embodiment of the process 1400, the one or more child node identifiers in each status record of the status information for the root node and each intermediate node may be based at least in part on the IP address assigned to the networked servers represented by the nodes in lower layers of the virtual tree structure to which the network node for the corresponding status record is directly linked. In this embodiment, the child node identifiers may be stored in the corresponding status information at the networked servers in relation to the establishing of the virtual tree structure.

In yet another even further embodiment, for each non-terminal node of the virtual tree structure, the process 1400 may also include sending a heartbeat query message to each network node identified by each child node identifier in the status record for the corresponding non-terminal node. In this embodiment, if the corresponding non-terminal node does not receive a heartbeat response message from each network node identified by each corresponding child node identifier within a predetermined time after sending the corresponding heartbeat query message, the process 1400 may determine the node identified by the corresponding child node identifier is out of service and store an “out of service” status in the node status of the status record for the node identifier that matches the corresponding child node identifier in the status information for the corresponding non-terminal node. In this embodiment, the non-terminal nodes of the virtual tree structure propagate the provisioning change to nodes indirectly linked to the corresponding non-terminal node in lower layers of the virtual tree structure to bypass “out of service” nodes directly and indirectly linked to the corresponding non-terminal node.

In an alternate further embodiment, after receiving the provisioning change at the terminal nodes of the virtual tree structure in conjunction with the propagating, the process 1400 may also include sending an acknowledgment from the corresponding terminal node to the node from which the provisioning change was received to acknowledge successful receipt. In this embodiment, for each non-terminal node, if the acknowledgment is not received within a predetermined time from any terminal node to which the provisioning change was directly propagated, an “out of service” status may be stored in the node status of the status record for the node identifier that matches the child node identifier of the corresponding terminal node in the status information for the corresponding non-terminal node.

In another further embodiment, the process 1400 may also include receiving an order for the provisioning change at any node of the virtual tree structure. In this embodiment, if the order was not received at the root node, the provisioning change may be sent to the root node from the node at which the order was received. In the embodiment being described, the provisioning change identifier in status records of the status information may be based at least in part on a unique identifier assigned to the corresponding provisioning change by the networked server at which the corresponding order was received. The provisioning change identifier may be stored in the corresponding status information at each networked server after the node at which the order was received broadcasts a “change in progress” message and the corresponding node receives the “change in progress” message.

In an even further embodiment of the process 1400, the provisioning change status in status records of the status information may be based at least in part on processing of the provisioning change associated with the corresponding provisioning change identifier. In this embodiment, a first provisioning status, indicating processing of the provisioning change is “in progress,” may be stored in the corresponding status information at each networked server after the corresponding node received the “change in progress” message associated with the corresponding provisioning change identifier. In another even further embodiment of the process 1400, a second provisioning status, indicating processing of the provisioning change is “locally complete,” may be stored in the corresponding status information after the corresponding node receives the provisioning change associated with the corresponding provisioning change identifier in conjunction with completion of the propagating to the corresponding node. In yet another even further embodiment of the process 1400, a third provisioning status, indicating processing of the provisioning change is “network complete,” may be stored in the corresponding status information after the corresponding node receives a “propagation complete” message from the root node in conjunction with completion of the propagating to the plurality of nodes.

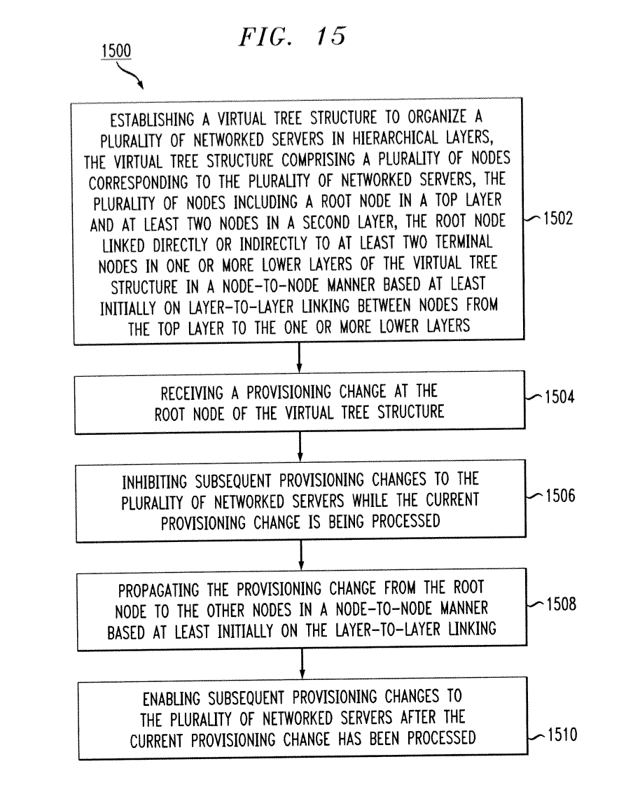

With reference to FIG. 15, an exemplary embodiment of a process 1500 for provisioning networked servers begins at 1502 where a virtual tree structure is established to organize a plurality of networked servers in hierarchical layers. The virtual tree structure including a plurality of nodes corresponding to the plurality of networked servers. The plurality of nodes including a root node in a top layer and at least two nodes in a second layer. The root node linked directly or indirectly to at least two terminal nodes in one or more lower layers of the virtual tree structure in a node-to-node manner based at least on layer-to-layer linking between nodes from the top layer to the one or more lower layers. Next, a provisioning change is received at the root node of the virtual tree structure (1504). At 1506, subsequent provisioning changes to the plurality of networked servers are inhibited while the current provisioning change is being processed. Next, the provisioning change is propagated from the root node to the other nodes in a node-to-node manner based at least in part on the virtual tree structure (1508). At 1510, subsequent provisioning changes to the plurality of networked servers are enabled after the current provisioning change has been processed.

In another embodiment of the process 1500, the virtual tree structure may include at least one intermediate node between the root node and the terminal nodes. In this embodiment, after receiving the provisioning change at the terminal nodes of the virtual tree structure in conjunction with the propagating, the process 1500 may also include sending an acknowledgment from the corresponding terminal node to the node from which the provisioning change was received to acknowledge successful receipt. In the embodiment being described, for each intermediate node, after receiving acknowledgments from nodes to which the provisioning change was directly propagated by the corresponding intermediate node, the process 1500 may also include sending an acknowledgment from the corresponding intermediate node to the node from which the provisioning change was received by the corresponding intermediate node to acknowledge successful receipt of the provisioning change by the corresponding intermediate node and successful receipt of the provisioning change by each node directly or indirectly linked to the corresponding intermediate node in lower layers of the virtual tree structure. In this embodiment, for the root node, after receiving acknowledgments from nodes to which the provisioning change was directly propagated by the root node, the process 1500 may also include broadcasting a propagation complete message from the root node to other nodes of the virtual tree structure to enable subsequent provisioning changes to the plurality of networked servers.

In a further embodiment, for each intermediate node, if the acknowledgment is not received within a normal predetermined time from any terminal node to which the provisioning change was directly propagated, the process 1500 may also include sending an out of service message to the node from which the provisioning change was received by the corresponding intermediate node to indicate the corresponding terminal node is out of service.

In an even further embodiment, for each intermediate node, if the acknowledgment is not received within a longer predetermined time from each node to which the provisioning change was directly propagated, the process 1500 may also include sending a failure message to the node from which the provisioning change was received by the corresponding intermediate node to indicate at least one node directly or indirectly linked to the corresponding intermediate node did not successfully receive the provisioning change. In this embodiment, the failure message may include out of service messages received by other intermediate nodes directly or indirectly linked to the corresponding intermediate node. In the embodiment being described, the longer predetermined time may be based at least in part on a known quantity of non-terminal nodes between the corresponding intermediate node and terminal nodes in the branches of the virtual tree structure originating from the corresponding intermediate node.

In another even further embodiment, for the root node, if the acknowledgment is not received within an even longer predetermined time from each node to which the provisioning change was directly propagated, the process 1500 may also include delaying the enabling of subsequent provisioning changes to the plurality of networked servers. In this embodiment, the even longer predetermined time may be based at least in part on a known quantity of non-terminal nodes between the root node and terminal nodes in the branches of the virtual tree structure originating from the root node.

In yet another even further embodiment, the process 1500 may also include overriding the delay and proceeding with the enabling of subsequent provisioning changes to the plurality of networked servers based at least in part on an assessment of circumstances.

In an alternate yet another even further embodiment, the process 1500 may also include repeating the propagating of the provisioning change to each node from which the acknowledgment was not previously received. In this embodiment, a propagation complete message may be broadcast after the root node receives the acknowledgment from each node from which the acknowledgment was not previously received. Next, the process may proceed with the enabling of subsequent provisioning changes to the plurality of networked servers.

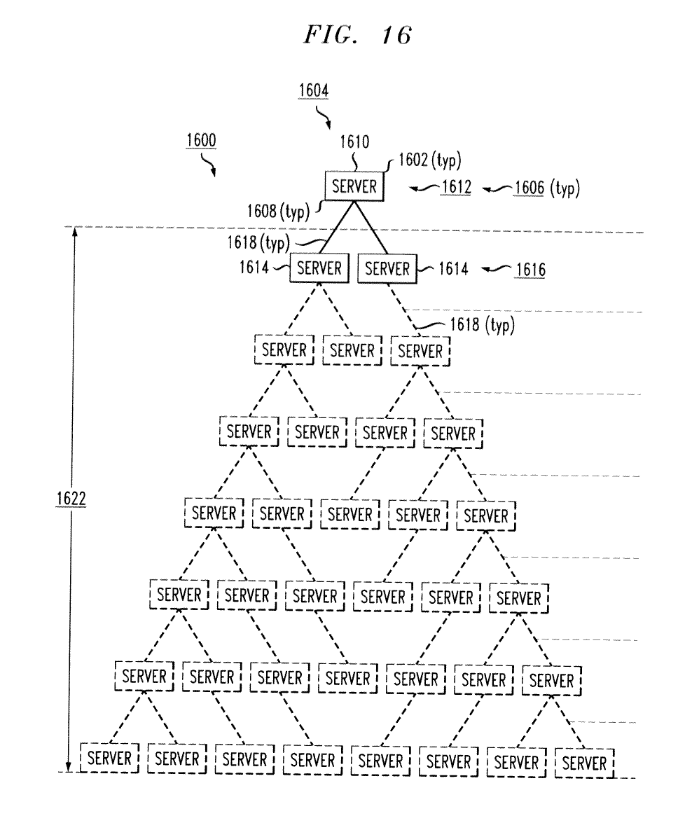

With reference to FIG. 16, an exemplary embodiment of a system for provisioning networked servers includes a communication network 1600 with a plurality of networked servers 1602. The plurality of networked servers 1602 are in operative communication with each other, other networked devices, and computers, terminals, and work stations having access to the communication network 1600. The actual network connections for the plurality of networked servers 1602 are not shown in FIG. 16. In conjunction with provisioning the networked servers, a virtual tree structure 1604 is established to organize the plurality of networked servers 1602 in hierarchical layers 1606. The virtual tree structure includes a plurality of nodes 1608 corresponding to the plurality of networked servers 1602. The plurality of nodes 1608 includes a root node 1610 in a top layer 1612 and at least two nodes 1614 in a second layer 1616. The root node 1610 is linked 1618 directly or indirectly to at least two terminal nodes 1620 in one or more lower layers 1622 of the virtual tree structure 1604 in a node-to-node manner based at least on layer-to-layer linking 1618 between nodes from the top layer 1612 to the one or more lower layers 1622.

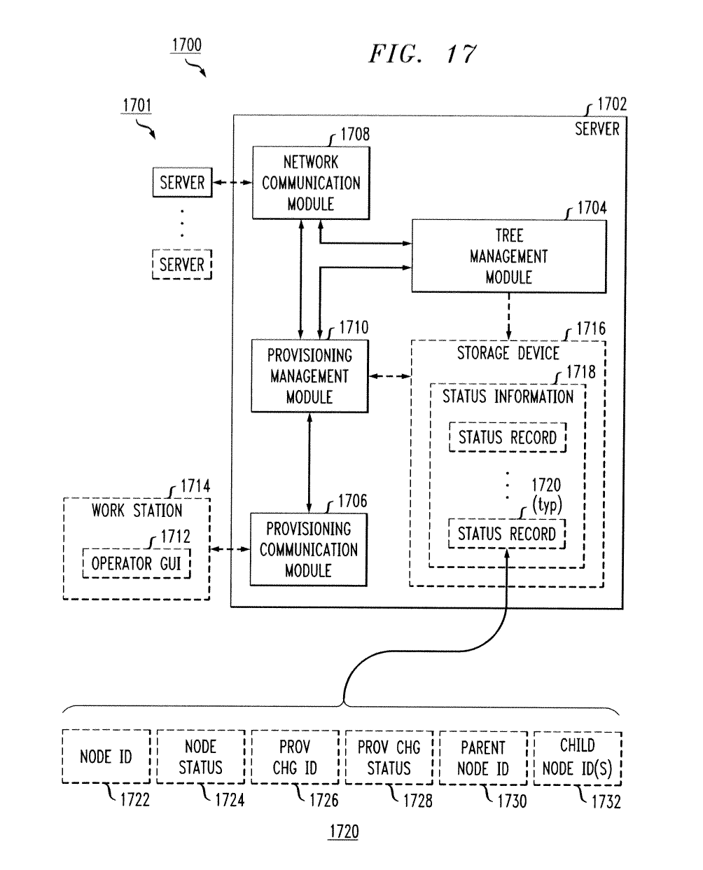

With reference to FIG. 17, an exemplary embodiment of a system for provisioning networked servers includes a communication network 1700 with a plurality of networked servers 1701. At least one networked server 1702 includes a tree management module 1704, a provisioning communication module 1706, a network communication module 1708, and a provisioning management module 1710.

The tree management module 1704 for establishing a virtual tree structure to organize the plurality of networked servers 1701 in hierarchical layers (see FIG. 16). The provisioning communication module 1706 adapted to receive a provisioning change from an operator graphical user interface (GUI) 1712 used by a work station 1714 in operative communication with the corresponding networked server 1702. The network communication module 1708 for sending the provisioning change to the root node from the node at which the order was received if the order was not received at the root node. The provisioning management module 1706 in operative communication with the tree management module 1704 and network communication module 1708 for inhibiting subsequent provisioning changes to the plurality of networked servers 1701 while the current provisioning change is being processed, propagating the provisioning change from the root node to the other nodes in a node-to-node manner based at least in part on the virtual tree structure, and enabling subsequent provisioning changes to the plurality of networked servers 1701 after the current provisioning change has been processed.

In another embodiment of the communication network 1700, non-terminal nodes of the virtual tree structure propagate the provisioning change to nodes indirectly linked to the corresponding non-terminal node in lower layers of the virtual tree structure to bypass “out of service” nodes directly and indirectly linked to the corresponding non-terminal node.

In yet another embodiment of the communication network 1700 each of the plurality of networked servers 1701 may include the tree management module 1702, provisioning communication module 1706, network communication module 1708, and provisioning management module 1710. In this embodiment, the virtual tree structure may include at least one intermediate node between the root node and the terminal nodes. In the embodiment being described, each networked server 1701, 1702 may include a local storage device 1716 for maintaining status information 1718 for at least a portion of the virtual tree structure. The local storage device 1716 for the root node may maintain status information 1718 with status records 1720 for each node of the virtual tree structure. The local storage device 1716 for each terminal node may maintain status information 1718 with status records 1720 for at least itself and the node in higher layers of the virtual tree structure to which it is directly linked. The local storage device 1716 for each intermediate node may maintain status information 1718 with status records 1720 for at least itself, the node in higher layers of the virtual tree structure to which it is directly linked, and each node in lower layers of the virtual tree structure to which it is directly or indirectly linked. Each local storage device 1716 may be adapted to store a node identifier 1722, a node status 1724, a provisioning change identifier 1726, a provisioning change status 1728, a parent node identifier 1730, and one or more child node identifiers 1732 for each status record 1720 of the status information 1718.

The paragraphs below provide various exemplary embodiments for exemplary status information within the nodes of the tree structure depicted in FIG. 9, with node C1 OOS at the outset of propagation of a new provisioning change. In a first exemplary embodiment, each node stores status information for the entire tree structure. In this embodiment, each “in service” node has the same status information. Each OOS node, would presumably have the status information present at the time communications with other nodes in the network were lost. The actual status information in OOS nodes is irrelevant to continuing operations while the node remains OOS. It only becomes relevant when the OOS node recovers and is able to communicate with its parent node. The tables below reflect the status information for “in service” node B1 and “OOS” node C1. The status information in nodes A, B2, C2, C3, D1, and D2 would be the same as node B1.

NODE B1 STATUS INFORMATION

| | | PROV | PROV | | | |
|---|---|---|---|---|---|---|
| NODE | NODE | CHG | CHG | PARENT | CHILD1 | CHILD2 |
| ID | STATUS | ID | STATUS | NODE ID | NODE ID | NODE ID |
| A | in service | B1-001 | in prog | | B1 | B2 |
| B1 | in service | B1-001 | in prog | A | C1 | C2 |
| B2 | in service | B1-001 | in prog | A | C3 | |
| C1 | OOS | D1-001 | net comp | B1 | D1 | D2 |
| C2 | in service | B1-001 | in prog | B1 | | |
| C3 | in service | B1-001 | in prog | B2 | | |
| D1 | in service | B1-001 | in prog | C1 | | |
| D2 | in service | B1-001 | in prog | C1 | | |

NODE C1 STATUS INFORMATION

| | | PROV | PROV | | | |
|---|---|---|---|---|---|---|
| NODE | NODE | CHG | CHG | PARENT | CHILD1 | CHILD2 |
| ID | STATUS | ID | STATUS | NODE ID | NODE ID | NODE ID |
| A | in service | D1-001 | net comp | | B1 | B2 |
| B1 | in service | D1-001 | net comp | A | C1 | C2 |
| B2 | in service | D1-001 | net comp | A | C3 | |
| C1 | in service | D1-001 | net comp | B1 | D1 | D2 |
| C2 | in service | D1-001 | net comp | B1 | | |
| C3 | in service | D1-001 | net comp | B2 | | |
| D1 | in service | D1-001 | net comp | C1 | | |
| D2 | in service | D1-001 | net comp | C1 | | |

In another exemplary embodiment, each node stores status information for itself and nodes in lower layers of the tree structure to which it is directly or indirectly linked. In this embodiment, the amount of status records in a given node is based on the amount of nodes originating from a given node. In essence, in this embodiment, each node maintains status records for itself and its offspring. Again, the status information for OOS node is irrelevant until the OOS node recovers and is able to communicate with its parent node. The tables below reflect the status information for each node.

NODE A STATUS INFORMATION

| | | PROV | PROV | | | |
|---|---|---|---|---|---|---|
| NODE | NODE | CHG | CHG | PARENT | CHILD1 | CHILD2 |
| ID | STATUS | ID | STATUS | NODE ID | NODE ID | NODE ID |
| A | in service | B1-001 | in prog | | B1 | B2 |
| B1 | in service | B1-001 | in prog | A | C1 | C2 |
| B2 | in service | B1-001 | in prog | A | C3 | |
| C1 | OOS | D1-001 | net comp | B1 | D1 | D2 |
| C2 | in service | B1-001 | in prog | B1 | | |
| C3 | in service | B1-001 | in prog | B2 | | |
| D1 | in service | B1-001 | in prog | C1 | | |
| D2 | in service | B1-001 | in prog | C1 | | |

NODE B1 STATUS INFORMATION

| | | PROV | PROV | | | |
|---|---|---|---|---|---|---|
| NODE | NODE | CHG | CHG | PARENT | CHILD1 | CHILD2 |
| ID | STATUS | ID | STATUS | NODE ID | NODE ID | NODE ID |
| B1 | in service | B1-001 | in prog | A | C1 | C2 |
| C1 | OOS | D1-001 | net comp | B1 | D1 | D2 |
| C2 | in service | B1-001 | in prog | B1 | | |
| D1 | in service | B1-001 | in prog | C1 | | |
| D2 | in service | B1-001 | in prog | C1 | | |

NODE B2 STATUS INFORMATION

| | | PROV | PROV | | | |
|---|---|---|---|---|---|---|
| NODE | NODE | CHG | CHG | PARENT | CHILD1 | CHILD2 |
| ID | STATUS | ID | STATUS | NODE ID | NODE ID | NODE ID |
| B2 | in service | B1-001 | in prog | A | C3 | |
| C3 | in service | B1-001 | in prog | B2 | | |

NODE C1 STATUS INFORMATION

| | | PROV | PROV | | | |
|---|---|---|---|---|---|---|
| NODE | NODE | CHG | CHG | PARENT | CHILD1 | CHILD2 |
| ID | STATUS | ID | STATUS | NODE ID | NODE ID | NODE ID |
| C1 | in service | D1-001 | net comp | B1 | D1 | D2 |
| D1 | in service | D1-001 | net comp | C1 | | |
| D2 | in service | D1-001 | net comp | C1 | | |

NODE C2 STATUS INFORMATION

| | | PROV | PROV | | | |
|---|---|---|---|---|---|---|
| NODE | NODE | CHG | CHG | PARENT | CHILD1 | CHILD2 |
| ID | STATUS | ID | STATUS | NODE ID | NODE ID | NODE ID |
| C2 | in service | B1-001 | in prog | B1 | | |

NODE C3 STATUS INFORMATION

| | | PROV | PROV | | | |
|---|---|---|---|---|---|---|
| NODE | NODE | CHG | CHG | PARENT | CHILD1 | CHILD2 |
| ID | STATUS | ID | STATUS | NODE ID | NODE ID | NODE ID |
| C3 | in service | B1-001 | in prog | B2 | | |

NODE D1 STATUS INFORMATION

| | | PROV | PROV | | | |
|---|---|---|---|---|---|---|
| NODE | NODE | CHG | CHG | PARENT | CHILD1 | CHILD2 |
| ID | STATUS | ID | STATUS | NODE ID | NODE ID | NODE ID |
| D1 | in service | B1-001 | in prog | C1 | | |

NODE D2 STATUS INFORMATION

| | | PROV | PROV | | | |
|---|---|---|---|---|---|---|
| NODE | NODE | CHG | CHG | PARENT | CHILD1 | CHILD2 |
| ID | STATUS | ID | STATUS | NODE ID | NODE ID | NODE ID |
| D2 | in service | B1-001 | in prog | C1 | | |

In yet another exemplary embodiment, each node stores status information for itself and nodes in lower layers of the tree structure to which it is directly or indirectly linked in the same status record. In this embodiment, the amount of fields in the status records in a given node is based on the amount of nodes originating from a given node. Again, in this embodiment, each node maintains status records for itself and its offspring. Again, the status information for OOS node is irrelevant until the OOS node recovers and is able to communicate with its parent node. The tables below reflect the status information for nodes A and B1. In this embodiment, the tables for nodes B2, C1, C2, D1, and D2 would be the same as those provided above in conjunction with the second exemplary embodiment of status information because none of these nodes have more than two children and no grandchildren or great-grandchildren for the exemplary tree structure.

NODE A STATUS INFORMATION

| | | | | | | | | | | GREAT | GREAT |
|---|---|---|---|---|---|---|---|---|---|---|---|
| | | PROV | PROV | | | | GRAND | GRAND | GRAND | GRAND | GRAND |
| NODE | NODE | CHG | CHG | PARENT | CHILD1 | CHILD2 | CHILD1 | CHILD2 | CHILD3 | CHILD1 | CHILD2 |
| ID | STATUS | ID | STATUS | NODE ID | NODE ID | NODE ID | NODE ID | NODE ID | NODE ID | NODE ID | NODE ID |
| A | In service | B1-001 | in prog | | B1 | B2 | C1 | C2 | C3 | D1 | D2 |
| B1 | In service | B1-001 | in prog | A | C1 | C2 | D1 | D2 | | | |
| B2 | In service | B1-001 | in prog | A | C3 | | | | | | |

NODE A STATUS INFORMATION

| | | | | | | | | | | GREAT | GREAT |
|---|---|---|---|---|---|---|---|---|---|---|---|
| | | PROV | PROV | | | | GRAND | GRAND | GRAND | GRAND | GRAND |
| NODE | NODE | CHG | CHG | PARENT | CHILD1 | CHILD2 | CHILD1 | CHILD2 | CHILD 3 | CHILD1 | CHILD2 |
| ID | STATUS | ID | STATUS | NODE ID | NODE ID | NODE ID | NODE ID | NODE ID | NODE ID | NODE ID | NODE ID |
| C1 | OOS | D1-001 | net comp | B1 | D1 | D2 | | | | | |
| C2 | In service | B1-001 | in prog | B1 | | | | | | | |
| C3 | In service | B1-001 | in prog | B2 | | | | | | | |
| D1 | In service | B1-001 | in prog | C1 | | | | | | | |
| D2 | In service | B1-001 | in prog | C1 | | | | | | | |

NODE A STATUS INFORMATION

| | | PROV | PROV | | | | GRAND | GRAND |
|---|---|---|---|---|---|---|---|---|
| NODE | NODE | CHG | CHG | PARENT | CHILD1 | CHILD2 | CHILD1 | CHILD2 |
| ID | STATUS | ID | STATUS | NODE ID | NODE ID | NODE ID | NODE ID | NODE ID |
| B1 | In service | B1-001 | in prog | A | C1 | C2 | D1 | D2 |
| C1 | OOS | D1-001 | net comp | B1 | D1 | D2 | | |
| C2 | In service | B1-001 | in prog | B1 | | | | |
| D1 | In service | B1-001 | in prog | C1 | | | | |
| D2 | In service | B1-001 | in prog | C1 | | | | |

In other embodiments, the status information may be arranged in any suitable combination of status records and status fields that permits the various propagation and fault tolerant features disclosed herein for provisioning networked servers and other networked devices to operate in a suitable manner.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for use in a networked server, comprising:
virtually linking a plurality of networked servers in hierarchical layers to form a virtual tree structure, the virtual tree structure comprising a plurality of nodes corresponding to the plurality of networked servers, the plurality of nodes including a root node in a top layer and at least two nodes in a second layer, the root node linked directly or indirectly to at least two terminal nodes in one or more lower layers of the virtual tree structure in a node-to-node manner based at least on layer-to-layer linking between nodes from the top layer to the one or more lower layers;
receiving a provisioning change at the root node of the virtual tree structure; and
propagating the provisioning change from the root node to the other nodes in a node-to-node manner based at least in part on the virtual tree structure.

2. The method set forth in claim 1 wherein the virtual tree structure is based at least in part on a binary tree structure.

3. The method set forth in claim 2 wherein the networked servers are deployed within a network and assigned internet protocol (IP) addresses, the method further comprising:
identifying a minimum value (d_min) among the IP addresses assigned to the networked servers;
identifying a maximum value (d_max) among the IP addresses assigned to the networked servers;
determining a mean value (d_root) from the minimum and maximum values based at least in part on (d_min+d_max)/2;
selecting the networked server with a value for the assigned IP address closest to the mean value as the root node for the virtual tree structure, using a floor or ceiling preference if values for two IP addresses are equally close to the mean value;
forming left branches of the virtual tree structure by recursively setting the IP address for the previously selected networked server to d_max, determining the mean value, and selecting the networked server for the next node as performed for the root node until there are no further IP addresses with values between d_min and d_max; and
forming right branches of the virtual tree structure by recursively setting the IP address for the previously selected networked server to d_min, determining the mean value, and selecting the networked server for the next node as performed for the root node until there are no further IP addresses with values between d_min and d_max.

4. The method set forth in claim 1, further comprising:
receiving an order for the provisioning change at any node of the virtual tree structure; and
if the order was not received at the root node, sending the provisioning change to the root node from the node at which the order was received.

5. The method set forth in claim 4 wherein the networked server represented by the node at which the order was received is in operative communication with a work station adapted to use an operator graphical user interface (GUI) from which the order was sent.

6. The method set forth in claim 4, further comprising:
if another order for a previous provisioning change is in progress in relation to the plurality of networked servers, discontinuing further processing of the current order for the provisioning change at the networked server at which the current order was received;
otherwise, broadcasting a change intention message from the node at which the current order was received to other nodes of the virtual tree structure; and
if a negative response message to the change intention message is received from any of the other nodes within a predetermined time after broadcasting the change intention message, broadcasting a retraction message to the other nodes to retract the change intention message and discontinuing further processing of the current order; otherwise, broadcasting a change in-progress message to the other nodes to inhibit the other nodes from processing subsequent provisioning changes while the current provisioning change is being processed.

7. The method set forth in claim 4, further comprising:
at the node at which the order was received, assigning a change identifier to the order and the provisioning change, the change identifier uniquely identifying the order and the provisioning change in relation to other provisioning changes for the plurality of networked servers.

8. The method set forth in claim 1 wherein non-terminal nodes of the virtual tree structure propagate the provisioning change to nodes indirectly linked to the corresponding non-terminal node in lower layers of the virtual tree structure to bypass “out of service” nodes directly and indirectly linked to the corresponding non-terminal node.

9. The method set forth in claim 1 wherein the virtual tree structure includes at least one intermediate node between the root node and the terminal nodes, each networked server maintaining status information for at least a portion of the virtual tree structure in a local storage device;
the root node maintaining status information with status records for each node of the virtual tree structure;
each terminal node maintaining status information with status records for at least itself and the node in higher layers of the virtual tree structure to which it is directly linked;
each intermediate node maintaining status information with status records for at least itself, the node in higher layers of the virtual tree structure to which it is directly linked, and each node in lower layers of the virtual tree structure to which it is directly or indirectly linked;
each status record adapted to store a node identifier, a node status, a provisioning change identifier, a provisioning change status, a parent node identifier, and one or more child node identifiers.

10. The method set forth in claim 9 wherein the node identifier in each status record of the status information for each node is based at least in part on an internet protocol (IP) address assigned to the networked server represented by the corresponding status record and the node identifiers are stored in the corresponding status information at the networked servers in relation to the establishing of the virtual tree structure.

11. The method set forth in claim 10 wherein the parent node identifier in each status record of the status information for each intermediate and terminal node is based at least in part on the IP address assigned to the networked server represented by the node in higher layers of the virtual tree structure to which the network node for the corresponding status record is directly linked and the parent node identifiers are stored in the corresponding status information at the networked servers in relation to the establishing of the virtual tree structure.

12. The method set forth in claim 11, further comprising:
for each non-root node of the virtual tree structure, sending a heartbeat query message to the network node identified by the parent node identifier in the status record for the corresponding non-root node; and
if the corresponding non-root node does not receive a heartbeat response message from the network node identified by the parent node identifier within a predetermined time after sending the corresponding heartbeat query message, determining the node identified by the parent node identifier is out of service and storing an “out of service” status in the node status of the status record for the node identifier that matches the parent node identifier in the status information for the corresponding non-terminal node.

13. The method set forth in claim 12 wherein the heartbeat query message to the network node identified by the corresponding parent node identifier includes the provisioning change identifier and provisioning change status for the corresponding non-root node, the method further comprising:
receiving a heartbeat response message from the network node identified by the corresponding parent node identifier and, if the provisioning change identifier and provisioning change status for the corresponding non-root node is behind the provisioning change identifier and provisioning change status at the network node identified by the corresponding parent node identifier, receiving the provisioning change from the network node identified by the corresponding parent node identifier at the corresponding non-root node.

14. The method set forth in claim 10 wherein the one or more child node identifiers in each status record of the status information for the root node and each intermediate node are based at least in part on the IP address assigned to the networked servers represented by the nodes in lower layers of the virtual tree structure to which the network node for the corresponding status record is directly linked and the child node identifiers are stored in the corresponding status information at the networked servers in relation to the establishing of the virtual tree structure.

15. The method set forth in claim 14, further comprising:
for each non-terminal node of the virtual tree structure, sending a heartbeat query message to each network node identified by each child node identifier in the status record for the corresponding non-terminal node; and
if the corresponding non-terminal node does not receive a heartbeat response message from each network node identified by each corresponding child node identifier within a predetermined time after sending the corresponding heartbeat query message, determining the node identified by the corresponding child node identifier is out of service, storing an “out of service” status in the node status of the status record for the node identifier that matches the corresponding child node identifier in the status information for the corresponding non-terminal node;
wherein the non-terminal nodes of the virtual tree structure propagate the provisioning change to nodes indirectly linked to the corresponding non-terminal node in lower layers of the virtual tree structure to bypass “out of service” nodes directly and indirectly linked to the corresponding non-terminal node.

16. The method set forth in claim 14, further comprising:
after receiving the provisioning change at the terminal nodes of the virtual tree structure in conjunction with the propagating, sending an acknowledgment from the corresponding terminal node to the node from which the provisioning change was received to acknowledge successful receipt;
for each non-terminal node, if the acknowledgment is not received within a predetermined time from any terminal node to which the provisioning change was directly propagated, storing an “out of service” status in the node status of the status record for the node identifier that matches the child node identifier of the corresponding terminal node in the status information for the corresponding non-terminal node.

17. The method set forth in claim 9, further comprising:
receiving an order for the provisioning change at any node of the virtual tree structure; and
if the order was not received at the root node, sending the provisioning change to the root node from the node at which the order was received;
wherein the provisioning change identifier in status records of the status information is based at least in part on a unique identifier assigned to the corresponding provisioning change by the networked server at which the corresponding order was received and the provisioning change identifier is stored in the corresponding status information at each networked server after the node at which the order was received broadcasts a “change in progress” message and the corresponding node receives the “change in progress” message.

18. The method set forth in claim 17 wherein the provisioning change status in status records of the status information is based at least in part on processing of the provisioning change associated with the corresponding provisioning change identifier and a first provisioning status, indicating processing of the provisioning change is “in progress,” is stored in the corresponding status information at each networked server after the corresponding node received the “change in progress” message associated with the corresponding provisioning change identifier.

19. The method set forth in claim 18 wherein a second provisioning status, indicating processing of the provisioning change is “locally complete,” is stored in the corresponding status information after the corresponding node receives the provisioning change associated with the corresponding provisioning change identifier in conjunction with completion of the propagating to the corresponding node.

20. The method set forth in claim 19 wherein a third provisioning status, indicating processing of the provisioning change is “network complete,” is stored in the corresponding status information after the corresponding node receives a “propagation complete” message from the root node in conjunction with completion of the propagating to the plurality of nodes.

21. A method for provisioning networked servers, comprising:
establishing a virtual tree structure to organize a plurality of networked servers in hierarchical layers, the virtual tree structure comprising a plurality of nodes corresponding to the plurality of networked servers, the plurality of nodes including a root node in a top layer and at least two nodes in a second layer, the root node linked directly or indirectly to at least two terminal nodes in one or more lower layers of the virtual tree structure in a node-to-node manner based at least on layer-to-layer linking between nodes from the top layer to the one or more lower layers;
receiving a provisioning change at the root node of the virtual tree structure;
inhibiting subsequent provisioning changes to the plurality of networked servers while the current provisioning change is being processed;
propagating the provisioning change from the root node to the other nodes in a node-to-node manner based at least in part on the virtual tree structure; and
enabling subsequent provisioning changes to the plurality of networked servers after the current provisioning change has been processed.

22. The method set forth in claim 21 wherein the virtual tree structure includes at least one intermediate node between the root node and the terminal nodes, further comprising:
after receiving the provisioning change at the terminal nodes of the virtual tree structure in conjunction with the propagating, sending an acknowledgment from the corresponding terminal node to the node from which the provisioning change was received to acknowledge successful receipt;
for each intermediate node, after receiving acknowledgments from nodes to which the provisioning change was directly propagated by the corresponding intermediate node, sending an acknowledgment from the corresponding intermediate node to the node from which the provisioning change was received by the corresponding intermediate node to acknowledge successful receipt of the provisioning change by the corresponding intermediate node and successful receipt of the provisioning change by each node directly or indirectly linked to the corresponding intermediate node in lower layers of the virtual tree structure; and
for the root node, after receiving acknowledgments from nodes to which the provisioning change was directly propagated by the root node, broadcasting a propagation complete message from the root node to other nodes of the virtual tree structure to enable subsequent provisioning changes to the plurality of networked servers.

23. The method set forth in claim 22, further comprising:
for each intermediate node, if the acknowledgment is not received within a normal predetermined time from any terminal node to which the provisioning change was directly propagated, sending an out of service message to the node from which the provisioning change was received by the corresponding intermediate node to indicate the corresponding terminal node is out of service.

24. The method set forth in claim 23, further comprising:
for each intermediate node, if the acknowledgment is not received within a longer predetermined time from each node to which the provisioning change was directly propagated, sending a failure message to the node from which the provisioning change was received by the corresponding intermediate node to indicate at least one node directly or indirectly linked to the corresponding intermediate node did not successfully receive the provisioning change, the failure message including out of service messages received by other intermediate nodes directly or indirectly linked to the corresponding intermediate node, the longer predetermined time based at least in part on a known quantity of non-terminal nodes between the corresponding intermediate node and terminal nodes in the branches of the virtual tree structure originating from the corresponding intermediate node.

25. The method set forth in claim 24 further comprising:
for the root node, if the acknowledgment is not received within an even longer predetermined time from each node to which the provisioning change was directly propagated, delaying the enabling of subsequent provisioning changes to the plurality of networked servers, the even longer predetermined time based at least in part on a known quantity of non-terminal nodes between the root node and terminal nodes in the branches of the virtual tree structure originating from the root node.

26. The method set forth in claim 25, further comprising:
overriding the delay and proceeding with the enabling of subsequent provisioning changes to the plurality of networked servers based at least in part on an assessment of circumstances.

27. The method set forth in claim 25, further comprising:
repeating the propagating of the provisioning change to each node from which the acknowledgment was not previously received;
broadcasting a propagation complete message after the root node receives the acknowledgment from each node from which the acknowledgment was not previously received; and
proceeding with the enabling of subsequent provisioning changes to the plurality of networked servers.

28. An apparatus for provisioning networked servers, comprising:
a communication network comprising a plurality of networked servers, at least one networked server comprising:
a tree management module for establishing a virtual tree structure to organize the plurality of networked servers in hierarchical layers, the virtual tree structure comprising a plurality of nodes corresponding to the plurality of networked servers, the plurality of nodes including a root node in a top layer and at least two nodes in a second layer, the root node linked directly or indirectly to at least two terminal nodes in one or more lower layers of the virtual tree structure in a node-to-node manner based at least on layer-to-layer linking between nodes from the top layer to the one or more lower layers;
a provisioning communication module adapted to receive a provisioning change from an operator graphical user interface (GUI) used by a work station in operative communication with the corresponding networked server;
a network communication module for sending the provisioning change to the root node from the node at which the order was received if the order was not received at the root node; and
a provisioning management module in operative communication with the tree management module and network communication module for inhibiting subsequent provisioning changes to the plurality of networked servers while the current provisioning change is being processed, propagating the provisioning change from the root node to the other nodes in a node-to-node manner based at least in part on the virtual tree structure, and enabling subsequent provisioning changes to the plurality of networked servers after the current provisioning change has been processed.

29. The apparatus set forth in claim 28 wherein non-terminal nodes of the virtual tree structure propagate the provisioning change to nodes indirectly linked to the corresponding non-terminal node in lower layers of the virtual tree structure to bypass “out of service” nodes directly and indirectly linked to the corresponding non-terminal node.

30. The apparatus set forth in claim 28 wherein each of the plurality of networked servers includes the tree management module, provisioning communication module, network communication module, and provisioning management module and the virtual tree structure includes at least one intermediate node between the root node and the terminal nodes, each networked server further comprising:
a local storage device for maintaining status information for at least a portion of the virtual tree structure;
wherein the local storage device for the root node is for maintaining status information with status records for each node of the virtual tree structure;
wherein the local storage device for each terminal node is for maintaining status information with status records for at least itself and the node in higher layers of the virtual tree structure to which it is directly linked;
wherein the local storage device for each intermediate node is for maintaining status information with status records for at least itself, the node in higher layers of the virtual tree structure to which it is directly linked, and each node in lower layers of the virtual tree structure to which it is directly or indirectly linked;
wherein each local storage device is adapted to store a node identifier, a node status, a provisioning change identifier, a provisioning change status, a parent node identifier, and one or more child node identifiers for each status record of the status information.
